(19) United States
(12) Patent Application Publication
(10) Pub. No.: US 2017/0031980 A1
(43) Pub. Date: Feb. 2, 2017

(54) Visual Aggregation Modeler System and Method for Performance Analysis and Optimization of Databases

(71) Applicant: InfoKarta, Inc., Devon, PA (US)

(72) Inventor: Michael J. Kamfonas, Devon, PA (US)

(21) Appl. No.: 14/810,671

(22) Filed: Jul. 28, 2015

(51) Int. Cl. G06F 17/30

(52) U.S. Cl. CPC G06F 17/30442

(57) ABSTRACT

An aggregation lattice provides an effective visualization tool to integrate complex and multifaceted feedback required for aggregation modeling. The aggregation lattice provides a framework for reasoning about aggregates, qualifying workloads that benefit from them, and picking most effective levels from a total performance perspective. A Visual Aggregate Modeler (VAM) tool puts the designer in control of choices made by using visualization to communicate aggregate query and maintenance costs along with other relevant factors assisting the designer in arriving at optimal aggregation materialization decisions. The VAM tool includes a SQL query parser and algorithms to determine the “free aggregation distance” that is the portion of aggregation cost queries incur because they do not have a close enough aggregate materialized, making informed performance enhancement cost/benefit decisions possible with existing workloads. A “materialization desirability” scale (“allow”-“discourage”-“avoid”) is implemented to systematically prioritize recastable aggregates and to limit them to specific dimension levels.

### TECHNICAL FIELD

The invention relates to database management systems and, more particularly, to a system and method for analyzing and optimizing the performance of database queries.

### BACKGROUND

Most analytic database management system vendors offer mature system support for aggregation maintenance and optimization. For example, DB2 offers Materialized Query Tables (MQT), Teradata offers Aggregate Join Indexes (AJI), and Oracle offers Materialized Views (MV). Business Intelligence tool vendors support aggregate awareness and dynamic sourcing, while online analytical processing (OLAP) technologies offer similar features. All too often, however, these powerful capabilities are used redundantly, without much forethought, and although they often improve query performance, they sometimes also disappoint, by impacting extract, transform, load (ETL) windows, availability, stability, sustainability and sometimes quality. Selecting optimal materialized aggregates can be achieved by iteratively modeling the materialization of the next most effective aggregate until certain thresholds of cost and benefit are met. Special considerations, such as the need to recast aggregates if dimensions change, complicate the process. Competing criteria must be simultaneously optimized to maintain minimum acceptable performance for the broadest spectrum of queries, to optimize total resource consumption for typical workloads that may favor certain aggregate levels and never or rarely touch others and, of course, to contain maintenance cost and time windows.

The prior art includes database management system (DBMS) implementations of aggregate awareness and optimization as well as methods for automatic maintenance of aggregate objects ensuring that they remain in sync with base data. Also, a variety of techniques for optimal aggregate selection and maintenance optimization for a given set of queries are discussed in the prior art. A system and technique is desired that enhances the prior art by providing a precise method of linking analytical query patterns to their aggregation costs and quantifying how much of this is opportunity cost that can be harvested through aggregate optimization. An exemplary tool is also desired that integrates optimization techniques from the prior art to concepts of “query aggregation level” and “free aggregation distance” and that allows human decisions to be interleaved with automated scoring and other feedback to result in a comprehensive performance CASE workbench for aggregation modeling, design, validation and enhancement for analytical databases. The systems and methods described herein address these and other needs in the database management art.

### SUMMARY

Given the dimensionality and aggregate cardinalities of an OLAP cube and certain workload assumptions, a Visual Aggregation Modeler (VAM) tool is provided that presents query and maintenance cost scores for various combinations of aggregate materializations initiated by the user in a progressive iterative process. The VAM tool implements methods to associate OLAP or statistical queries or query patterns to their ideal vertices of the aggregation lattice derived from the dimensionality of the OLAP cube. Optimal aggregate selection follows an iterative process, allowing human decision at each step after considering competing priorities and cost scores for assumed workloads. Such workloads are characterized as weight profiles covering the vertices of the aggregation lattice, formulated manually based on projected query patterns, or derived from actual queries extracted and parsed from the DBMS history logs. The result of this analysis typically leads to a conventional design-test-build process relying on means external to the VAM tool for implementing the chosen aggregate levels in the database, initializing them and making them available to the optimizer exploiting the mechanisms each targeted DBMS supports. The VAM tool described herein does not affect the execution of queries in real time. A workload module takes the text from the history of executed queries along with execution details logged by the DBMS to determine the demand frequency by aggregation level derived using the query aggregation level. This information is then converted to weight profiles used in cost scoring for the optimal selection of materialized aggregates, driven from actual workload patterns rather than “assumptions” or requirements. The VAM tool also calculates a “free aggregation distance” that quantifies the magnitude of opportunity for performance improvement via aggregates.

The systems and methods described herein are based on a framework for reasoning about aggregates, qualifying workloads that benefit from them, and picking most effective levels from a total performance perspective. The VAM tool described herein puts the designer in control of the choices made by using visualization to communicate aggregate query and maintenance costs along with other relevant factors assisting the designer in arriving at optimal aggregation materialization decisions.

The VAM tool described herein introduces (a) a method to associate OLAP or aggregation queries to vertices of the aggregation lattice, (b) a way to break down aggregation cost and quantify performance opportunity through aggregates in OLAP query workloads, and (c) a way to interleave human input in between optimization steps to account for factors not easily captured by automated methods. The VAM tool further integrates conventional systems with the above methods for evaluating and enhancing aggregates in OLAP databases. In particular, the method includes associating database queries with aggregate levels by introducing the notions of S-Level (selection aggregation level) and G-Level (grouping aggregation level) used to derive the Q-Level (query aggregation level), as well as the M-Level (materialization level) along with algorithms to compute such levels from actual queries. The method of quantifying performance contribution of aggregates described herein further includes dividing aggregation cost into intrinsic and discretionary components and introducing the notion of free aggregation distance. The method of interleaving human input into automated iterative processes as described herein further includes visual presentation of a color-coded aggregation lattice of all possible aggregation levels, conveying query and maintenance cost scores and competing priorities to users, highlighting through color desirable and undesirable choices, and letting the user pick and iterate through a sequence of selections until satisfactory coverage and cost thresholds are met. The VAM tool described herein models the aggregation lattice and implements prioritization modules that discourage recasting and weight cost scoring to match actual or projected workload activity in the database to the same model used for aggregate selection. The VAM tool implements the interjection of human decisions in between steps of algorithmic optimization to facilitate the ergonomics of human-machine interaction with the aggregation lattice.

Exemplary embodiments are characterized by methods and an associated visual design tool for integrating all required aspects of aggregate selection and evaluation. An aggregation lattice provides an effective visualization tool to integrate complex and multifaceted feedback required for aggregation modeling. The visual design tool puts the designer in control of an iterative exploratory process that enables consideration of factors that are not easy to address with fully automated algorithms. An optional “materialization desirability” scale (“allow”-“discourage”-“avoid”) is implemented to systematically prioritize recastable aggregates and to limit them to specific dimensions at specific levels. Also, derivation of the “aggregation level” and “free aggregation distance” of real queries enables actual workloads to be measured against the same yardstick used in aggregate design.

Exemplary embodiments are implemented with a database management system (DBMS) for managing a database that contains relational tables and views that can be construed as dimensional facts and dimensions and queried as relational OLAP cubes, where the DBMS includes a SQL engine that optimizes and executes queries to the database in a way that it exploits summary tables or materialized aggregate objects to accelerate the performance of queries. A visual aggregation modeler tool that enables a user to determine which materialized aggregates, at affordable maintenance cost, maximize performance of database aggregation queries that execute in the SQL engine. The visual aggregation modeler (VAM) tool in an exemplary embodiment includes a settings module that stores dimensionality data that defines each aggregation lattice that corresponds to dimensional facts of the database, along with cardinalities at each vertex, and weight profiles for vertices of each aggregation lattice residing in a database that is subject to aggregation analysis. The VAM tool also includes a model module that retains the aggregation lattice model state and a state of each node of each aggregation lattice. The model module further composes a topology of the aggregation lattice of the database from at least the dimensionality data and further calculates query and maintenance cost scores for each node and a total weighted query cost for each node including contributions of the weight profiles. A display module of the visual aggregation modeler renders a display including an aggregation lattice graph including nodes and next rank edges of the aggregation lattice. The display informs a user of the materialization status of each node along with the query and maintenance cost scores in visual and analytic form and enables the user to score feedback of each node of the aggregation lattice. A user response and acceptance module enables the user to interact with the aggregation lattice graph to select nodes and to change data in the setting module for visualization of the effects of the changed data on the aggregation lattice. A persistence module is used to save models to disk including settings data, relevant files, and the state of each node of the aggregation lattice.

The exemplary VAM tool enables both the determination of optimal aggregates and the assessment of their effectiveness in a database management system. Optimality is construed both in terms of reducing response time of queries and decreasing total resource consumption of executing workloads in the database system. In the exemplary embodiment, such a method includes the steps of creating an aggregation lattice of the database from dimensionality data, assigning cardinality for each vertex (representing an aggregation level), weighing the vertices proportionally to the frequency queries exercise them, and calculating certain raw and weighted query cost scores, and cost scores for maintaining such aggregates. These scores are communicated visually through the display, informing the user who follows an iterative process of choosing new vertices (representing aggregation levels) to materialize. As more aggregates are materialized, query cost scores get reduced and maintenance cost scores increase. The user stops this iterative process when the displayed scores indicate that performance objectives are met.

In the exemplary embodiments, exemplary methods are implemented by the model module by first determining the aggregation lattice topology from the dimensionality data. Then the model module performs the following calculations following each user action. It first calculates the derivation base of each node, which is the smallest materialized aggregate that the node can be derived from. Then, the model module further calculates the query cost score for each node as the ratio of the cardinality of its derivation base to the cardinality of the node itself and may apply a weight proportional to the frequency of its use. The model module also calculates a total maintenance cost score as a number proportional to a projected cost of building each materialized aggregate from its derivation base. The model module further translates the query cost score to a color that the display module renders on the display to reflect a comparison of the cardinality ratio to at least one threshold indicating the cost of the query. The user may then provide an input to the user response and acceptance module to select a node, alter its materialization status, or take some other action.

Other exemplary embodiments of the visual aggregation modeler and associated method include an optional graph search module that enables the user to select a list of nodes of the aggregation lattice and to see their common descendants and union of ascendants highlighted on the display. This auxiliary capability, although a non-essential part of the systems and methods, helps the user easily recognize node dependencies useful in the design process, particularly for graphs with many nodes and edges.

Still other optional exemplary embodiments of the visual aggregation modeler and associated method enables the user to color code a boundary of each node in the aggregation lattice based on a materialization desirability classification whereby recastable aggregates are discouraged except for limited specific dimension levels of the aggregation lattice that the user explicitly allows. The materialization desirability is derived from recasting settings stored by the settings module and each selected node is placed in one of three groups: a group to allow materialization for nodes that are not subject to recasting, a group to discourage materialization where recasting has been enabled by the user for the affected dimensions and levels, and a group to avoid materialization that involves dimensions subject to recasting at levels that the user has not approved for recasting.

In yet another exemplary embodiment, the visual aggregation modeler tool and associated method includes an optional workload analysis module that analyzes each query of the workload to determine its aggregation level and, by counting how many queries are associated with each aggregation level, the workload analysis module creates weight profiles that reflect actual workload behavior. The workload analysis module may also provide a column-level manifest including a mapping between tables/columns to a characterization as a dimension level or metric. The weight profiles are then used in the model module to evaluate optimal aggregates for these actual workloads. The workload analysis module may also provide data used to calculate the free aggregation distance for each query that quantifies the portion of the aggregation cost incurred that could be avoided if a better aggregation level closer to the level of the query were available. The sum or average aggregation distance by node or averaged across all nodes can be used as a measure of how much opportunity for performance improvement exists for the particular node or in the whole system, respectively.

### BRIEF DESCRIPTION OF THE DRAWINGS

The above-mentioned and other beneficial features of the systems and methods described herein will be apparent from the following detailed description of the exemplary embodiments in connection with the attached figures, of which:

FIG. 1A illustrates an exemplary embodiment of a database management system adapted to implement a visual aggregation modeler tool.

FIG. 1B illustrates an optimized target database that is configured to run on one or more standalone DBMS servers.

FIG. 2 illustrates a “level grid” for a fact with additive metrics M1 and M2 measured against the five dimension keys D1-D5.

FIG. 3 illustrates three lattice examples for two-dimensional aggregation lattices that are 2, 3, and 4 levels deep.

FIG. 4 illustrates two lattice examples for three-dimensional aggregation lattices that are 2 and 3 levels deep.

FIG. 5 illustrates an exemplary query profile for a five-dimensional aggregation hierarchy.

FIG. 6 illustrates an intrinsic, free aggregation and pre-aggregation cost separated for the same scenario as in FIG. 5 except that an aggregate is added at level (1,1,1,1,2).

FIG. 7 illustrates aggregation query patterns based on the relative positioning of the free aggregation distances and their intrinsic cost.

FIG. 8 illustrates an exemplary design of the visual aggregation modeler tool.

FIG. 9 illustrates the process flow of the visual aggregation modeler tool of FIG. 8.

FIG. 10 illustrates the workload analysis module for constructing the weight profiles used by the visual aggregation modeler tool.

FIG. 11 illustrates a sample aggregation lattice graph generated by the visual aggregation modeler tool.

### DETAILED DESCRIPTION OF ILLUSTRATIVE EMBODIMENTS

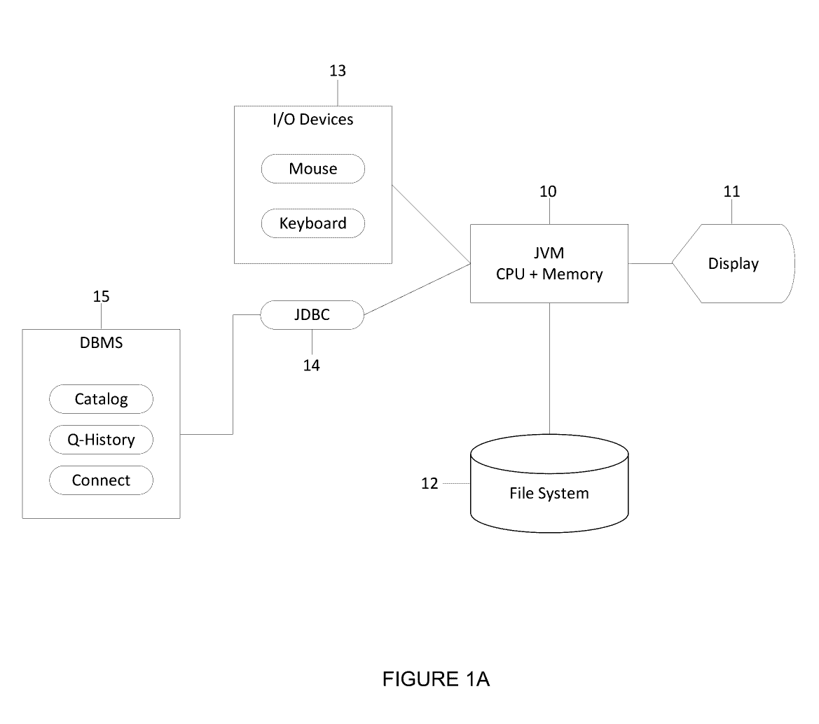

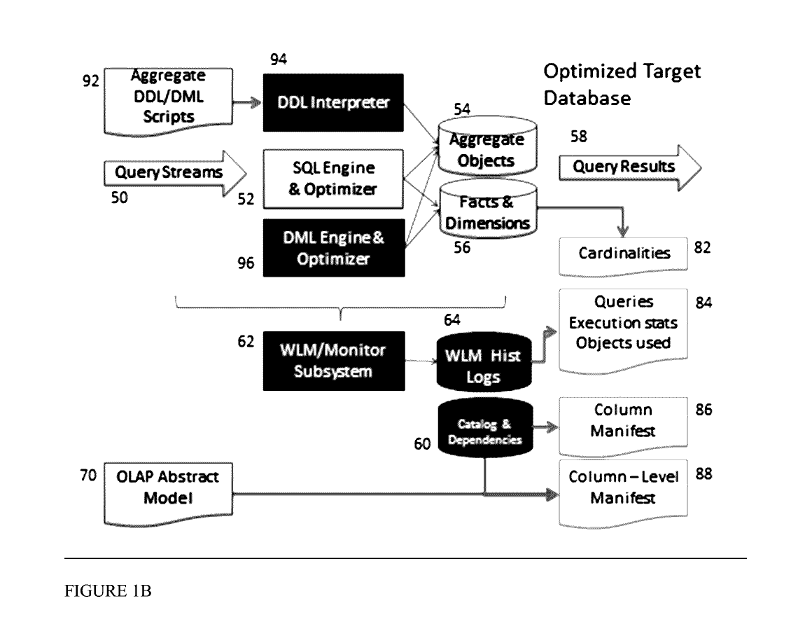

A detailed description of illustrative embodiments will now be described with reference to FIGS. 1-11. Although this description provides a detailed example of possible implementations, it should be noted that these details are intended to be exemplary and in no way delimit the scope of the invention.

### TERMINOLOGY

The following terms will be used throughout this description in accordance with the following definitions.

Dimension Level: The single digit (0 to 9) that denotes the level of a specific dimension. The lowest level is always 0, also referred to as the bottom of the dimension. The highest level is always referred to as the “top.”

Rank: The row of the aggregation lattice depicting aggregation levels that are derived from aggregation levels of the next lower rank by unit aggregation. A unit aggregation is the aggregation by one dimension by one level. The rank is identified as an integer, and is computed as the sum of all dimension level digits identifying the aggregation level. One can visualize starting from the bottom of the lattice 0-level, and aggregating by raising one dimension at a time by one. Then for all aggregation levels of that rank, raise one level at a time for each of their dimensions and so on, building the lattice in layers. Each layer is the next rank of nodes (vertices.)

Aggregation Level: A level represented by a node (vertex) of the aggregation lattice. Aggregation levels are all levels data can be grouped along the given set of dimensions and levels. Aggregation levels are identified by a vector of digits that correspond to the level of each dimension forming that aggregation level.

Aggregate: An aggregation level that has been materialized. Also called materialization point, materialized level or materialized aggregate. When one refers to all aggregates, by convention the cube base is included, which may be a fact or transaction detail.

Derivable: An aggregation level A is derivable from a lower level aggregation level B if it is possible to construct A by aggregation of B. In order for A to be derivable from B, each dimension level digit of B must be less than or equal to the respective dimension level digit of A. On the lattice graph, if A is derivable from B, then B is a descendent of A and A is an ascendant of B.

Derivation Base: The derivation base B of an aggregation level A is the materialized aggregate with the lowest cardinality from which A is derivable.

Node (Vertex): They both represent aggregation levels in the aggregation lattice. Although both terms are used interchangeably, the term Node refers to the concept, while Vertex is used to denote the geometric manifestation of the node on the lattice graph. Nodes whose underlying aggregation levels are persisted as physical tables (i.e. they are materialized aggregates) are referred to as materialized nodes.

Cardinality: A numeric value used to score the cost of aggregation. In its simplest form, it can be a number proportional to the row count in a fact or detail table, or proportional to the number of data pages accessed, or a score combining I/O and CPU cost associated with scanning and spooling a constant number of rows, or any other appropriate sizing metric.

Cardinality Ratio: The cost of a scan of lower level materialized data at a materialized level M that is required for extracting a row at aggregation level A. This ratio is calculated as the cardinality at M divided by the cardinality at A, and it is the primary driver of query cost scoring.

S-Level: The aggregation level at which a query filters. It is the level of the tables/columns used in filtering selections.

G-Level: the aggregation level at which a query groups.

Q-Level: Also referred to as the Query Level, is the highest aggregation level from which both the S-Level and the G-Level can be derived.

M-Level: Is the level of the materialized aggregate used by a query. There is a subtle difference between the fact table that may be referenced in the query, and the table that the query actually uses. By parsing the query, one can obtain the referenced table. By looking at a performance monitor log or a plan explain in the DBMS, one can ascertain the actual data source used.

Intrinsic Cost: The cardinality ratio between S-Level and Q-Level. This aggregation cost is not possible to optimize through aggregates because it is intrinsic to the query. One also refers to the Intrinsic Rank as the rank difference between the S-Level rank and Q-Level rank.

Discretionary Cost or Free Aggregation Distance: The cardinality ratio between the Q-Level and M-Level. This represents the cost that one can improve with aggregates. The Free Aggregation Rank is the rank difference between the Q-Level and M-Level.

Pre-Aggregation cost: The cardinality ratio between M-Level and Base-Fact-Level. It represents the cost of aggregation already taken out of the query by precomputing the M-Level aggregate.

### Platform Overview

The Visual Aggregation Modeler (VAM) components described below can be implemented on various platforms. The VAM need not be connected to a DBMS, although an optional connection can enable transferring query text, monitoring/cataloging information and issuing queries to get counts while building the lattice. FIG. 1A provides one example of an implementation platform. As illustrated in FIG. 1A, the implementation platform may include:

1. A Java Virtual Machine (JVM) 10, including a CPU and memory adapted to run the system described herein;
2. A visual raster display 11, capable of displaying graphics and text, preferably with at least 1920×1080 pixel resolution interfacing with the JVM 10;
3. Persistent storage and file system 12 accessible by the JVM 10 and having at least 1 GB available space;
4. Mouse (2-button) and keyboard input devices 13 and controller interfacing to the JVM 10; and
5. An optional JDBC interface 14 to the optimized remote database management system (DBMS) 15.

The target database optimized by this application is typically configured to run on one or more standalone DBMS servers. The most typical such DBMS is relational, used for reporting or analytic functions, such as a data warehouse that stores base and aggregate data and is accessed via SQL. The Visual Aggregation Modeler (VAM) tool, although it optimizes the performance of these target DBMSs, it does not have to reside on the same platform, nor does it have to be directly connected to them. Such a DBMS platform is usually a complex system with many subsystems and components. The components described in FIG. 1B are those that are relevant to the described systems and methods and that pertains to the use of a relational system for OLAP drilldown and analytic workloads.

The primary flow in the exemplary DBMS of FIG. 1B begins with the query streams 50 arriving from applications or directly connected users. Each query stream 50 contains SQL requests that are parsed, optimized and executed by the SQL Engine & Optimizer 52. The execution entails retrieving stored data from facts and dimensions 56 and, if appropriate, from aggregate objects 54. One of the optimization steps by the SQL optimizer 52 is to check if the query is subsumed by an existing aggregate qualified object that is more efficient to scan than the base tables, and possibly may avoid some of the joins that are already included in the pre-aggregated object. If such an aggregate exists, and it fulfills all necessary qualification conditions (e.g., it is authorized, current, consistent and supports adequate precision), then the optimizer 52 will rewrite the query to an equivalent simpler one that uses that aggregate in place of the base fact and any pre-joined dimensions. The query results 58 are then sent back to the application. Another possibility is for the incoming query to already be written against aggregate tables. In those cases, the query-issuing application or user is aware of the aggregate table. In either case, regardless of how the aggregate was accessed, its existence provides an opportunity to reduce the cost of data scans and joins resulting in a performance advantage measured in multiples or even levels of magnitude over accessing base data.

The workload management and monitoring subsystem 62, aside from prioritizing and managing the workload and managing database resources, may also capture certain details about each query, including its original source text, the optimized text, the objects affected, execution details and statistics, such as CPU consumption, I/O cost, row counts processed and result set size among others. The way this information is handled varies from DBMS to DBMS but eventually it is stored and made available through system views and tables referred to as WLM History Logs 64. Catalog information about the structures (e.g., tables, columns, views) and any system-known dependencies among objects is retained in the Catalog & Dependencies 60 and is also available for querying in the form of tables or views.

A major factor affecting DBMS performance is the selection of appropriate aggregates to implement in Aggregate Objects 54 of the DBMS, so that the optimizer 52 can redirect expensive queries to those more efficient aggregate objects. Aggregates, like other database changes, before being created in the DBMS are first tested and when approved, database administrators process Aggregate DDL scripts 92 through the DDL interpreter 94 to generate the physical aggregate objects 54. After their creation, these objects must be properly initialized so that aggregates and base facts are 100% in sync. From that point forward, the DBMS ensures that any changes to base data processed through the DML Engine and Optimizer 96 are done in a way that the respective aggregates remain in sync. Maintaining the aggregates, however, can be a costly operation and it runs the risk of impacting allotted data maintenance windows.

The information needed to perform Aggregate analysis and optimization activities can be fabricated based on general abstractions about the system, or it can be very specific to an existing system and actual workloads executing on that system. The former approach is taken when the system is under development or the performance of ad hoc envelopes of queries that may not appear on specific workloads, or if the workloads are in question or changing. The latter is useful when evaluating performance issues of existing systems with representative workloads. In both cases a key piece of information is the OLAP Abstract Model 70 which is typically a document that defines what the dimensions are, the levels of each dimension, and what database objects implement them. This information is used to build the aggregation lattice from the number and level of dimensions. Each vertex of this lattice, representing an aggregation level, has to be associated with its cardinality provided at 82, collected with sampling queries on actual data. When analyzing existing systems, human judgment is required to combine the abstract model with Catalog Information 60 to produce the Column Manifest 86 and Column-Level Manifest 88, a column-dimension-level detail list used to map actual query parse trees to aggregation levels if actual workloads are being analyzed. The Column-Level Manifest 88 is a list of each query-table-column appearing in workloads with details of their usage and catalog information. Object Execution Stats 84 is information extracted from the WLM Logs that include the query text and the actual objects used during execution. This is required when analyzing actual workloads where queries may be redirected by the DBMS optimizer to point to aggregate objects.

A challenge in the art of aggregate design is how to combine costs/benefit and other key factors to optimize performance for envelopes of all possible ad hoc queries allowed on a system rather than specific hotspots or problem queries. Another challenge is how to overlay and compare actual workload behavior to the same models used for the existing aggregate design to evaluate its effectiveness, and inform a new design cycle.

### The Fundamentals: “Level Grid” and “Aggregation Lattice”

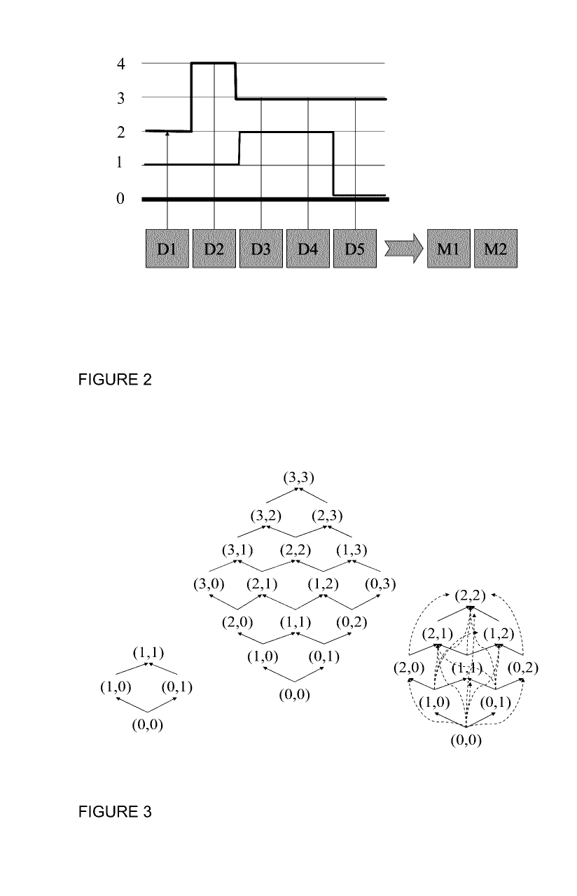

The “Level Grid” illustrated in FIG. 2 shows a fact (bottom) with additive metrics M1, M2, against the five dimension keys D1-D5 of the fact. The dimensions are represented by vertical lines stemming off these keys with their levels numbered starting from zero. The straight line across from “0” at the bottom denotes the base level of the fact, while the line at (2,4,3,3,3) indicates the top aggregate along all dimensions—a single row summary. Any line that cuts across the five dimensions at a valid level represents an aggregation. For example, an aggregation in FIG. 1A is illustrated by the line at level (1,1,2,2,0).

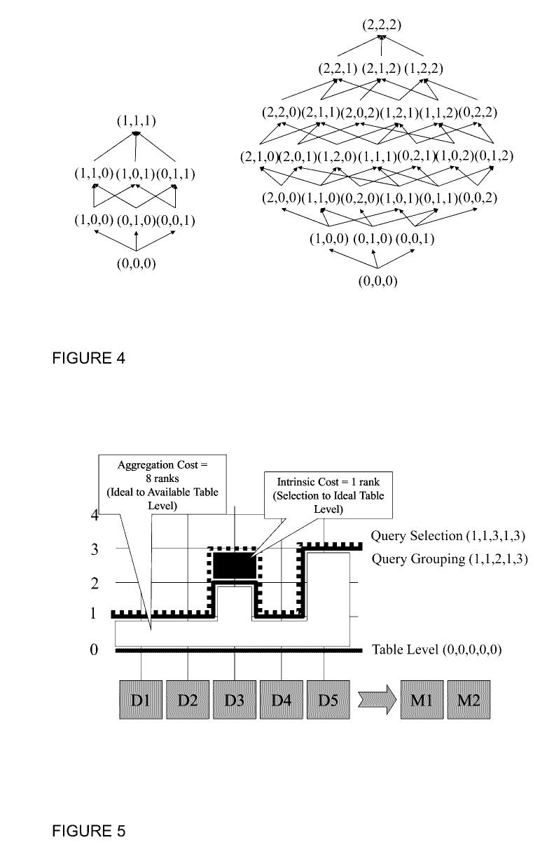

The “Aggregation Lattice” is a second type of graph used to depict all possible aggregations from the base fact to the highest level. Every aggregation-defining line that cuts across the “Level Grid” corresponds to a node of the Aggregation Lattice. The lattice also has edges that indicate all possible derivation paths of each aggregate from lower levels. The example in FIG. 2 has 3×5×4×4×4=960 possible such lines of dimension level combinations or 960 nodes in the corresponding Aggregation Lattice. Since a lattice of that size would be too cluttered to visualize, FIGS. 3 and 4 show smaller examples with two and three dimensions, respectively. The following conventions are used to construct these lattices:

1. Each dimension is a tree of uniform depth, with its nodes organized in levels, with a single top node representing “all” or “any”. Leaf nodes are at level 0; their parents are at level 1; their parents at level 2 etc. The root (top) node level is n−1, where n represents the number of levels in the dimension. Simple codes with no hierarchical structure can be represented in two levels: the code itself at level 0, and a single parent denoting the “any code” at level 1.
2. There are as many possible aggregates as there are combinations of participating dimension levels. The term “multi-levels” is used to distinguish them from single dimension levels. A bottom multi-level for a three-dimensional model is (0,0,0) and it represents the base fact; the top can be something like (4,5,4) representing all stores, all product, for all time. There is a subtle difference between the base fact (0,0,0) and the transactional detail level, where all event data are stored. The methodology described herein sometimes uses an additional node, referred to as level −1 below the (0,0,0) level to denote the non-aggregated underlying event data. Another approach is, by convention, to assume that level (0,0,0) captures the transaction level detail if the transaction details are actually used as the base fact. For real situations, the difference between the transactional detail and the lowest level grouping in cardinality rarely exceeds 2:1 or 3:1. All possible multi-levels between top and bottom are connected by arcs depicting every possible single-dimension single-level aggregation path. The graph so formed is a lattice, “the Aggregation Lattice,” a complete map of all valid aggregation paths.

Three lattice examples of a two-dimensional hierarchy are depicted in FIG. 3. The number of nodes (or vertices) is the product of the number of levels for each dimension; from left to right, 2×2=4, 4×4=16 and 3×3=9. Similarly, FIG. 4 depicts three-dimensional lattices for two and three level hierarchies with 2×2×2=8 and 3×3×3=27 nodes, respectively. For illustration purposes, transitive aggregations are shown using dashed lines for the 3×3 lattice in FIG. 3.

There is more than one way to derive an aggregation from lower levels, and the number of ways increases as the number of dimensions increase. For example, (2,0,2) is derived by aggregating one level along the third dimension of (2,0,1) or along the first dimension of (1,0,2), or by aggregating any of the lower levels, i.e. (2,0,0), (1,0,1), (0,0,2) or (1,0,0), (0,0,1) and (0,0,0).

In FIGS. 3 and 4, the vertices are shown in layers, each representing multi-levels of the same “rank” or “aggregation distance” from the bottom. The lowest, single vertex represents the base fact and has rank 0; the next layer-up has vertices with rank 1, and so on. The rank correlates to the “level of magnitude” of an aggregate in terms of row count. To illustrate this, visualize an ideal mart where all dimensions are independent with the same depth and cardinality ratio 10:1 from level to level. If the base fact has 1 million rows, the vertices in the next layer represent multi-levels (or aggregates) with rank 1 and 100,000 rows. The next layer of rank 2 will have cardinalities ten times less and so on. Of course, in reality dimensions are not independent and cardinality ratios vary. This causes aggregates of the same rank to have very different row-counts. This is why the notion of “rank” is used to talk about the topology, but actual cardinalities are computed to analyze performance potential.

In accordance with the disclosed method, the first step in the process is to form a “Loaded, Weighted Aggregation Lattice” as follows:

1. Establish the dimensionality of each fact. This is an important step, particularly if the underlying schema is non-dimensional. This entails organizing the model into dimensions, picking the relevant levels and pruning those dimensions that should not be considered or that have no value for aggregate construction.
2. Formulate an “aggregation lattice” of all level combinations along the dimensions.
3. Load nodes with cardinalities derived from actual data sampling to arrive at the “Loaded Aggregation Lattice.”
4. Consider additional expected or projected usage, physical organization constraints etc., arriving at one or more “Weighted Loaded Aggregation Lattices” which are, in turn, used to select optimal aggregate candidates.

### Query Patterns and Aggregation

In order for the aggregation lattice to be useful, it needs to be credibly linked to query performance. In particular, what query patterns, and what types of workloads are conducive to performance improvement through aggregates? In accordance with the disclosed method, every query, however complex, is associated with four multi-levels as shown in FIG. 5:

1. The selection/filtering multi-level is the lowest applied filtering level along each of the dimensions. This is determined by the “where” clause of an SQL query. For dimensions that do not appear in the where-clause, the top level of the hierarchy representing “all” or “any” is implied. For example, filtering for product category A for 2015Q1 automatically assumes “all stores.” This multi-level is referred to as the S-Level (for Selection Level) and is shown as the dotted line (1,1,3,1,3) in FIG. 5.
2. The grouping multi-level is the lowest level along each dimension found in the “group by” clause of the query. This level is referred to as the G-Level and is shown in FIG. 5 as the query grouping (1,1,2,1,3) in FIG. 5.
3. The materialized table multi-level is the actual level of the table being queried—the M-Level (Materialized Data level.) The materialized level, in the absence of aggregates, is the base fact level. The further apart S-Level and M-Levels are, the higher the cost of the query. Intuitively, the higher the filtering level means more rows to scan; the lower the materialized level the more granular the data to be scanned. FIG. 5 shows a fact with five dimensions, the S-Level (dotted), G-Level (solid) and the M-Level, in this case (0,0,0,0,0).
4. The query multi-level is the ideal materialized data aggregate the query could run on (Q-Level), if it existed. It usually coincides with the G-Level but not always. The query level is formed by checking each dimension S and G levels and picking the lower of the two.

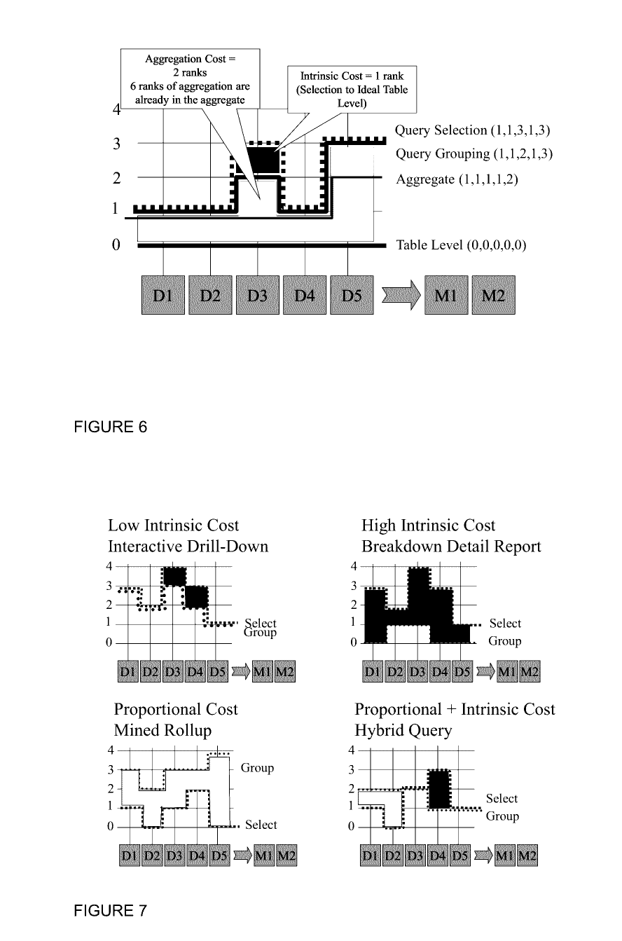

FIG. 6 depicts the same scenario shown in FIG. 5 with an aggregate added at level (1,1,1,1,2). The Total Aggregation Cost from base data to the query result corresponds to the area between S-Level and Base and it ties back to the sum of Aggregate Maintenance plus Query Run-Time Cost of the transformation chain shown in FIG. 5. This aggregation cost may be broken down into component costs as follows:
Pre-Aggregation Cost: The cost to pre-aggregate data from the base level to the available M-Level aggregate used by the query, i.e. between the S-Level and M-Level. This corresponds to the Aggregate Maintenance Cost in FIG. 6.
Run-Time Aggregation Cost: This cost is represented by the area between the S-Level and the M-Level, where data actually is queried from. It corresponds to the Run-Time Aggregation Cost in FIG. 6. The Q-Level divides this area into two parts, thus further breaking this cost down to two component costs:
   Intrinsic Aggregation Cost: The portion of the aggregation that is inherent to the query and no aggregate can reduce. It is represented by the area between the S-Level and the Q-Level. Low intrinsic cost characterizes queries whose scan size can be relatively small if a good aggregate can be provided for them to run on. Conversely, high intrinsic cost queries require large numbers of qualifying rows scanned per point selected, even if the best possible aggregate existed for them to run on.
   Discretionary Aggregation Cost (Free Aggregation Distance): This is the run-time cost incurred to aggregate data from an available materialized aggregate up to the query level, i.e., the area between the Q-Level and the M-Level. It is discretionary since it is in the user's discretion to materialize closer to the query level and absorb some or all of this cost. The term “Free Aggregation Distance” is another intuitive way of describing the portion of the aggregation that is free to traverse prior to query execution. Essentially, introducing aggregates converts Discretionary (Free) to Pre-Aggregation cost.

Aggregation queries can be classified into distinct patterns based on the relative positioning of these lines (levels) and their intrinsic cost. FIG. 6 shows four such patterns:

1. Drill-Down Interactive Queries are typically initiated from a point the user selects and requests a lower level drill down. The selected cells are at some “selection level” (S-Level) and the drill-down level defines the “grouping level” requested (G-Level.) The drill-down is typically the next level along one or two dimensions. In lattice terms, the S and G levels are close to each other, maybe a couple of ranks apart, meaning that only a few G-Level rows are required per S-Level selected. In other words, the intrinsic cost is low and consequently sustaining interactive response times is feasible as long as an aggregate exists in the proximity of the query level. The top left diagram of FIG. 7 shows how from a selection level at (3,2,4,3,1) drilling down along two dimensions delivers grouped data at (3,2,3,2,1). The shaded area is proportional to the intrinsic cost of the query.
2. Breakdown Reports are characterized by a relatively broad selection and relatively low-level grouping of data. For example, select Product Categories X, Y and Z for last month for this and last year, and return amounts and quantities sold by product class, by store and day. Such a pattern is shown at the top-right diagram of FIG. 7. These queries have a high intrinsic cost because of the large distance between selection and grouping levels. They can only be run on relatively low level detail and they require a large number of rows. They are classified as “reports” since they can be rather voluminous due to the level of detail they convey. This type of query may be used to feed graphic visual components to plot highly detailed graphs. In those cases naming their classification as “reports” may be too restrictive.
3. Mining and Hybrid Rollups are queries that select data along some or all dimensions at levels lower than they group them. The lower diagrams of FIG. 7 show such query patterns mining low level data and rolling them up to cluster or classify them along higher levels of the same dimensions. For example, for the query “Select specific SKUs supplied by a list of vendors last year and group them by class and district,” one needs to mine data for specific products at the item level, and then roll-up counts and amounts to higher levels of these taxonomies.

In view of the above description of the terminology, a description will now be provided explaining how optimal levels are chosen and the details behind their implementation.

### Optimal Levels

One school of thought is to “architect” aggregates during the data design process and to base them on application/reporting requirements that dictate what the hot spots are. This inevitably results in hardwired aggregates, often modeled as prime structures and taking a life of their own, difficult to adjust and likely to leave large portions of the lattice uncovered. A different approach is to monitor the system workload and to create aggregates when needed in response to performance issues when they arise. This approach is adaptive and responds to changing workloads; however, it may lead to proliferation of costly high proximity application-specific aggregates that are easy to add but hard to refactor. This, in turn, is likely to interfere with their sustainability and evolution, leading to resource saturation and premature need for capacity upgrades.

The analytic approach favored in an exemplary embodiment combines the “architected” with the “iterative” and is based on the following three premises:
Optimal aggregate selection is driven from the data itself and is not directly dictated by specific reporting requirements.
A rational framework for quantifying and analyzing performance is essential, and optimization should take into account the total system, its workloads and service levels.
Coupling of applications to aggregates must be avoided so that changes are painless down the road.

There are three pre-existing types of capabilities in the prior art that pertain to aggregate optimization. First, published algorithms on optimal aggregate selection and optimizing the aggregation process are generally known. For example, the Visual Aggregate Modeler described below may use the costing method suggested by Harinarayan, et al. as noted below. Second, systems that fully automate aggregate selection and management under certain OLAP technologies employing lazy methods of materializing aggregates when retrieved for the first time are effective for limited situations where the problem fits available technology, sizing and complexity. However, the majority of aggregate design today relies on the designer to make the aggregate level selection and maintenance choices. Third, advisor tools associated with specific DBMSs that given a set of queries can recommend aggregations to improve response time assume that the queries presented are immutable, and they often result in multiple redundant aggregates that the designer can use as a starting point. Due to the nature of aggregations, it is hard for these results to be combined and assess their holistic impact, or to address multiple scenarios and converge to a non-redundant solution. Often optimization requires adjusting the model or the queries or both, and needs to be anchored in a more abstract and resilient model.

An exemplary algorithm that may be used to derive optimal aggregates to materialize is a variant of the technique proposed by Harinarayan, Rajaraman, and Ullman, “Implementing Data Cubes Effectively,” ACM/SIGMOD, June 1996, Montreal, Canada, p. 205, which iteratively seeks the “best next aggregate” that minimizes the sum of materialized rows scanned to run the equivalent of selecting all aggregated rows at every vertex of the lattice. As more aggregate materializations are factored into the model, this sum is reduced progressively as already aggregated data can get scanned instead of the base data. This method yields optimal results for one iteration; however, it is not necessarily optimal when multiple materializations are chosen one by one in a sequential manner. One way to mitigate the problem is to allow the user to intervene and manually test alternate materializations, if the candidate nodes can be limited. The method exemplified by the VAM tool is a variation of the Harinarayan, Rajaraman, and Ullman technique which has been employed under the methodology collectively referred to as the Versioned Dimensional Model (VDM) that only considers aggregates of “adequate aggregation distance” so that selections very close to already materialized levels or too far from them are not considered in each iteration. As chosen aggregates are factored into the model, all vertices of the lattice end up “close enough” to some chosen aggregate thus covering the whole lattice while weighing nodes to favor hot spots. After desirable levels have been selected to optimize query response times and to minimize total query discretionary aggregation cost, the cost of maintenance is evaluated. Intermediate aggregate materializations can reduce the total maintenance cost by reducing the number of lower level large scans in exchange for higher level smaller scans that can be leveraged for the building of multiple materialized aggregates.

The premises and characteristics of the optimal aggregation approach may be described as:

1. Optimal aggregations are best determined by the data topology and cardinalities depicted in a properly weighted and loaded aggregation lattice. Requirements should be used to construct, prune, load or weigh the lattice, but should not dictate aggregate levels.
2. Maximize sharing. One common aggregate is better than two close ones over the same fact supporting two different applications.
3. As a general rule, the more effective the aggregates chosen to materialize, the more expensive they will be to maintain. Chains of aggregates built one on top of the other facilitate maintenance, but tend to leave large areas of the lattice uncovered. Proper aggregate selection should provide complete coverage of the lattice and address hot spots by weighting them accordingly.
4. Avoid trivial aggregations. Aggregating 100 billion rows into a 90 billion row aggregate, at face value, makes a negligible improvement in performance and is not worth the cost of its maintenance. Such close aggregates may only be justified if they resolve other costly derivations, such as:

a. Pre-joining master-detail or other major facts to avoid query-time fact joins;

b. Pivoting vertically organized items into flat easier queried columnar form; and

c. Materializing derived columns used for filtering where the underlying technology requires it.

Such situations can often be addressed in the base model design, but by the time they become an issue aggregates are the easier way to resolve them.
5. Avoid recastable aggregations if possible. If an as-is dimension participates in the lattice, the lowest and highest levels are by definition non-recastable. Levels in between may require restating historical aggregates if the hierarchy changes. Evaluate the feasibility of pruning recastable multi-levels from the aggregation lattice. Although good to avoid, recastable aggregates may be a necessary evil to achieve desired service levels, and they should not be discarded a priori.
6. Follow the rule of proportionality: The magnitude of the work executed by the system to ingest a data change and maintain all dependent structures must be proportional to the magnitude of the change ingested. This is a generalization of the earlier point about recasting. Examples where this rule may get violated are:

a. A change of one row of a dimension may impact millions of fact rows (as-is recasting);

b. The use of MIN or MAX in an aggregate may cause history refresh if a row that determined the minimum or maximum is removed; and

c. Data maintenance practices—Refreshing a dimension by replacing data as opposed to merging changes will cause the whole tower of dependent aggregates to be refreshed. In most cases, proportionality violations can be addressed by tweaking scripts, adding an index, running statistics, setting up proper constraints, etc. It is important that these issues get shaken out of the system before aggregates are considered. Aggregates should not be used as a crutch or workaround to basic performance tuning.

### The “Visual Aggregation Modeler”

### Overview

The Visual Aggregation Modeler supports the above modeling approach to assist data designers in modeling and improving the performance of relational or non-relational OLAP cubes or normalized models with heavy aggregation activity exhibiting dimensional query patterns, through aggregate materialization, taking into account the following competing priorities and constraints:
Dimensionality and levels that define the shape of the aggregation lattice;
Threshold(s) of “free aggregation distance” that can be handled at execution time;
Query cost score by aggregation level;
Total weighted query cost score across all levels for any given workload;
Total maintenance cost of materialized aggregates;
Support for both coverage (minimum service level for any aggregation level) and total performance (with weighted workload per aggregation level);
(Optional) Weight profiles derived from actual workload queries; and
(Optional) Avoidance of recasting (slow changing dimension problem).

The operational concept of the Visual Aggregation Modeler described herein is to put the user-designer in control and to explore materialization choices, under multiple scenarios and “what-if” paths while receiving ample visual and analytic feedback every step of the way. This way, human decisions are interleaved with automated steps enabling considerations and trade-offs that are not possible with fully automated algorithms or strictly manual methods to be factored into the materialized aggregate design.

### Design of the Visual Aggregation Modeler

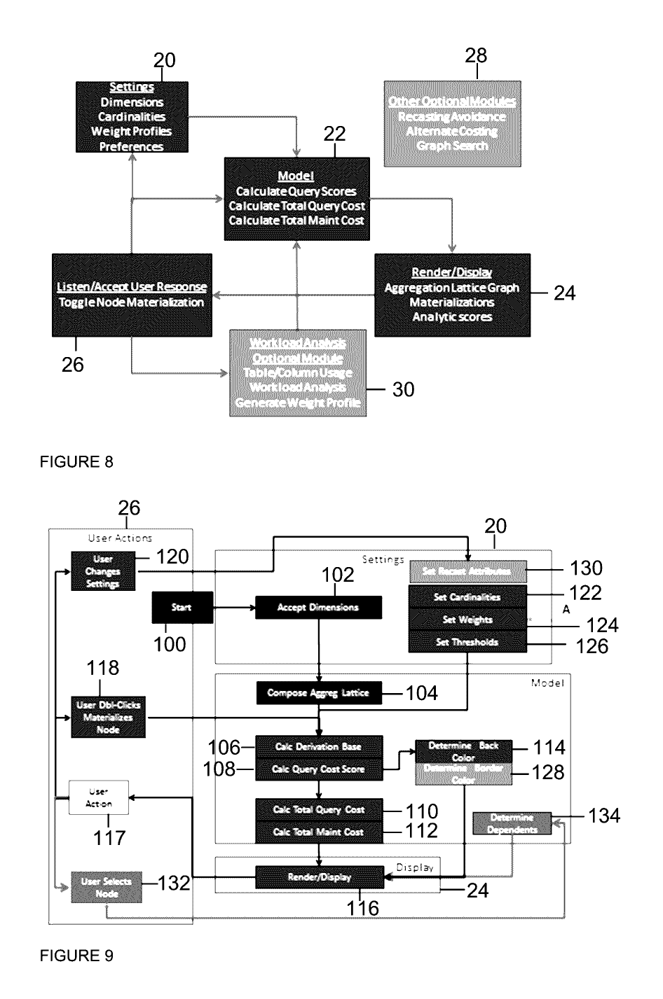

FIG. 8 illustrates an exemplary design of the visual aggregation modeler. As will be explained in more detail below, the visual aggregation modeler is formed of a series of software/hardware modules that may access the required database management system content via optional direct interface or transfer information through importable text files generated manually or through SQL output from the database system being optimized. The application preferably operates on a Java Virtual Machine (JVM) 10 and includes a display 11, disk with file system 12 and input-output devices (mouse and keyboard) 13 as described above with respect to FIG. 1A. As shown in FIG. 8, the visual aggregation modeler generally comprises a settings module 20, a model module 22, a display module 24, a user response and acceptance module 26, and optional graph search/recasting avoidance/alternate costing module 28 and optional workload analysis module 30. These modules will now be described.

The settings module 20 accepts and retains categories of information including dimensionality, cardinalities, weight profiles, thresholds, preferences, and other settings. The dimensionality data includes the name and a list of levels for each dimension. All combinations of dimension levels define the set of all aggregation levels as vertices in the aggregation lattice. Aggregation levels are identified by the ordered list of their dimension levels. The cardinality data may be ingested using any mechanism (file import, editor or direct update) that may be used to associate a cardinality value to each aggregation level. As a result, each aggregation level is associated with a cardinality numeric value. Optionally, multiple cardinalities may be maintained for each aggregation level, one of which is considered active at a time and used in calculations. This option allows modeling to be based on various types of cardinality metrics, for example, the number of rows, size in kilobytes, or number of data pages (blocks). One or more weight profiles associate every aggregation level to a weight proportional to the number of queries exhibiting that query aggregation level (Q-Level as defined in the fundamentals section above).

The thresholds, preferences and other settings data use cardinality ratio thresholds to delineate the boundary between acceptable and unacceptable response time. It is up to the user to determine these thresholds, depending on the service levels assumed, the concurrency expected, data size, technology and capacity of the DBMS. The basic alternative is to identify a low and a high threshold cardinality ratio. Cardinality ratios below the low threshold corresponds to acceptable performance (green zone), cardinality ratios above the high threshold corresponds to unacceptable performance (red zone), and cardinality ratios between the two thresholds signify the transitional area of modest performance (yellow zone.) Other options of varying complexity can be implemented to map cardinality ratios to a human perception scale between acceptable and unacceptable response times.

The model module 22 retains the state of the model and each node of the Aggregation Lattice. It repeats the computations after every user action and before rendering and displaying the results. The model state includes the degree (the number of dimensions), the list of dimensions and their levels, aggregation lattice nodes (vertices) and edges, and constants, options, thresholds and preferences. The state of each node includes the aggregation lattice topology and visual state, ID including concatenation of dimension level digits, rank, derivation base, cardinalities, and weight profiles. As will be explained in more detail below, the model module 22 also composes the Aggregation Lattice topology from dimensionality data, calculates the “derivation base” of each node, which is the closest materialized level to that node, calculates the “query cost score” for each node, which is a score proportional to the discretionary aggregation cost (free aggregation distance) for a nominal query, calculates the “total weighted query cost,” and calculates the “total maintenance cost.”

The display module 24 uses the results of the calculations and the model state provided by the model module 22 to render and display graphical and textual information to the user. For example, display module 24 renders and repaints the Aggregation Lattice Graph by displaying the “Aggregation Lattice” vertices and next rank edges. The display module 24 also paints each vertex. If a node is materialized, background vertices are painted a first color (e.g., cyan) and cyan straight edges from the derivation base are shown. Otherwise, the background is painted a color derived from the query cost score using the “query color mapping.” Analytic data is also displayed to the user including total maintenance cost score, total weighted query cost score, and optionally, breakdown and deltas such as node count and total weighted score breakdown by green, yellow, red score range, and total maintenance cost score and count breakdown by desirability scale, if implemented (e.g., Allow, Discourage, Avoid). Optional Deltas point out the difference (positive or negative) in query and maintenance costs by each materialization action.

The user response and acceptance module 26 captures user responses and initiates consequent actions. For example, the user may point to a node and toggle its materialization status by left-double clicking on the mouse. The user also may right-click to open a pop-up menu of secondary actions such as invoking settings, maintenance functions and preferences (e.g. altering the active weight profile or cardinality set). Other windows and housekeeping options may also be selected, such as zooming and scaling, saving and opening models etc.

### Process Flow of Visual Aggregation Modeler

FIG. 9 illustrates the process flow among the visual aggregation modeler components of FIG. 8. The indicated actions are performed in the indicated modules. It is noted that the steps start 100, accept dimensions 102, and compose aggregation lattice 104 are initialization processes that occur at the beginning of the process. In these steps, the dimensionality is accepted, and based on the dimensionality, the topology of the lattice is determined. Steps 106-126 denote the basic process to be described in more detail below. Steps 128 and 130 implement the Add-On Recasting Avoidance Feature which will also be described in more detail below. Finally, steps 132 and 134 denote the optional graph search option components. Boxes that are connected should be viewed as sequentially visited/executed top-to-bottom. Those that are marked as optional can be skipped if not applicable. In the “settings” case, the recast attributes, cardinalities, weights and thresholds are visited in that order, but only user requested changes invoke activity.

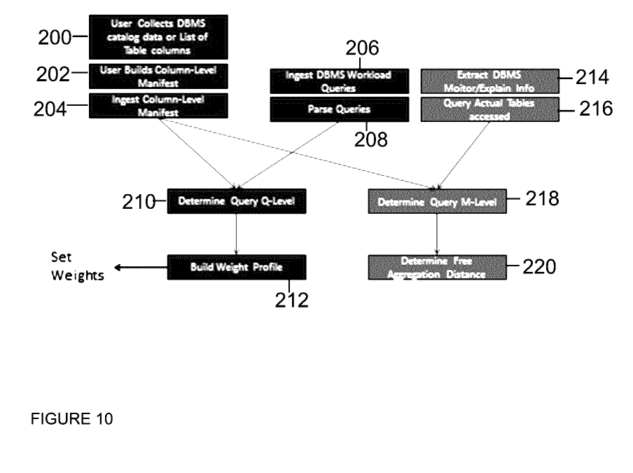

The Arrow “A” feeding the Set Weights step 124 from the right in FIG. 9 signifies the feed from the optional Workload Analysis Module 30 whose diagram is shown in FIG. 10, and adds two types of features. In particular, as shown in FIG. 10, steps 200-212 organize the manifest required and parse the queries in a workload to determine the Q-Level. From this, a weight profile can be constructed at step 212, which can be fed back through the “Set Weights” step 124 of FIG. 9 to model actual workload distribution. Additionally, steps 214-220 derive the aggregation free distance from actual queries which can be used in further analysis by the user. These steps will also be described in further detail below.

### Detailed Process Steps (FIG. 9)

### Compose Aggregation Lattice

Referring back to FIG. 9, the visual aggregation process starts at step 100 and accepts dimensions at step 102 for use in composing the aggregation lattice topology from the dimensionality data at step 104. As described above with respect to FIGS. 2-7, the topology of the aggregation lattice calculated at step 104 includes the list of nodes (vertices) and the list of edges. In particular, the list of nodes is composed by defining each node by an ordered list of levels that corresponds to the ordered list of dimensions. The bottom node (0, . . . ,0) is always created representing the base fact of non-aggregated data. All combinations of (d₀, . . . ,dₙ) are created such that level dᵢ is a valid level for dimension i. This process produces as many nodes as the product of the level-count of all dimensions, which corresponds to all aggregation levels defined by all possible level combinations.

The list of nodes is maintained in the model, and each node contains the following attributes: ID—the numeric value formed by concatenating all level digits that define it; Array-ID—the same as the ID, but the dimension levels are kept as elements of an array of size equal to the number of dimensions; and Rank—the sum of all level digits. The edges for the lattice include only elementary paths, consisting of those edges that connect a node (vertex) only to nodes of the next rank below it from which they are derivable. Rank 0 is the bottom and has no edges below it. Then, starting from Rank 1, iterate through each rank in ascending order as follows:

For each node N(d₀, . . . ,dₙ) in the rank connect an edge to it from each node of the next rank B that N can be derived from the set of nodes Bⱼ (b₀, . . . ,bₙ) that are defined by substituting for all possible values of j from 0 to n that result in valid B nodes where:

bᵢ=dᵢ|i≠j

bᵢ=dᵢ−1|i=ĵdᵢ>0

These are simply all valid nodes with one of the dimensions of N lowered by one level, ignoring those that end up with invalid levels (dimensions lower than 0).

### Calculate “Derivation Base”

At step 106, the derivation base is calculated for each node N in the aggregation lattice, by searching the transitive closure of all descendants of node N and identifying those that are materialized nodes. The Derivation Base of the node is the materialized node so identified with minimum cardinality. Optionally, a different function can be provided by users for the determination of the derivation base. For example, instead of selecting the materialized descendant with minimum cardinality, additional factors, such as collocation, may be considered by the algorithm, whereby collocated materialized nodes may be favored over slightly smaller non-collocated ones. Such alternate algorithms can be introduced by users of the system and can override the default calculation.

### Calculate “Query Cost Score”

At step 108, the query cost score is calculated for each node N in the aggregation lattice as the cardinality ratio:

### Cardinality of Derivation Base of N/Cardinality of N.

Optionally, alternative functions known to those skilled in the art can be provided to derive query cost scores.

### Calculate “Total Weighted Query Cost Score”

At step 110, the total weighted query cost score is calculated by first normalizing the weights as follows:
Using the weight w, of each node and with n denoting the number of nodes of the lattice, the normalized weight of each node is calculated as the ratio of the weight to the sum of all weights, multiplied by the number of nodes:

$${\overline{w}}_{i} = n \frac{{w}_{i}}{\sum {w}_{i}}$$

The total weighted query cost Q is calculated as the sum of the calculated query cost scores qᵢ multiplied by the respective normalized weight:

Q=Σₙqᵢw̅ᵢ.

Alternative total weighted calculations can be used. The method ensures that the sum of normalized weights is always equal to the number of nodes of the lattice, so that they can be compared in the same scale as non-weighted total cost (where weight of every node is equal to 1). Like any score, the individual normalized weights may be scaled to an easier readable range using a common factor without impacting the total weighted cost.

### Calculate “Total Maintenance Cost Score”

The total maintenance cost score is calculated at step 112 as a number proportional to the projected cost of building each materialized aggregate from its derivation base. The heuristic used approximates that cost as the sum of source and target cardinality for each of the materializations. For example, for each materialized aggregate, add the cardinality of its “derivation base” and its own cardinality and sum all so derived cost scores to calculate the Total Maintenance Cost Score. Optionally, the score may be scaled for readability by, for example, dividing by a million.

Determine Color from Query Cost Score Using Thresholds

At step 114, the raw query cost score calculated at step 108 is translated to a backfill color reflecting the utility curve defined using the two thresholds:
a. The cardinality ratio that can be handled by the DBMS 15 at execution time to support the concurrency and service levels required. A default cardinality ratio threshold of 8:1 is set if no other value is provided. Scores below this value are represented as green. The user is encouraged to set the low and high thresholds to values that reflect the specifics of their use case and the DBMS technology used.
b. The cardinality ratio that marks the limit beyond which performance degrades. Scores above this threshold are shown as red. A default of 15:1 is used if no other value is provided. The rage between 9 and 14 is used to paint the transition colors in the yellow range.
   If the thresholds selected allow a very wide range between them, the degradation of colors becomes so subtle that they may be undistinguishable from green or red. The color range between green and red is quantized to 3, 5 or 7 levels by the utility function, collectively referred to as the yellow zone, so that degradations are visible. The color range chosen for the green-yellow-red scale may be, for example, the first third of the range of colors (a 5-level quantization) in the spectrum defined in the Java Color library and they are generated by the following call:
Color.getHSBColor((float) i/(n*3), (float) 0.5, (float) 1.0);
   where n in this case is 5 number of colors, and i ranges from 0-4 and identifies each of the colors from red to green.

The actual Query Cost Score Q is mapped to the respective color as follows:
If the Query Cost Score is less than the low threshold, then use the highest value in the color scale (in this case 4);
If the Query Cost Score is greater than the high threshold, then use color 0; and
For the values in between, extrapolate the Query Cost Score (QCS) in the range between the low and high thresholds and quantize to the number of intermediate colors (excluding green and red) as follows:

Floor((QCS−LowThres)/(HighThres−LowThres))*(N−1)

where N is the number of discrete colors.

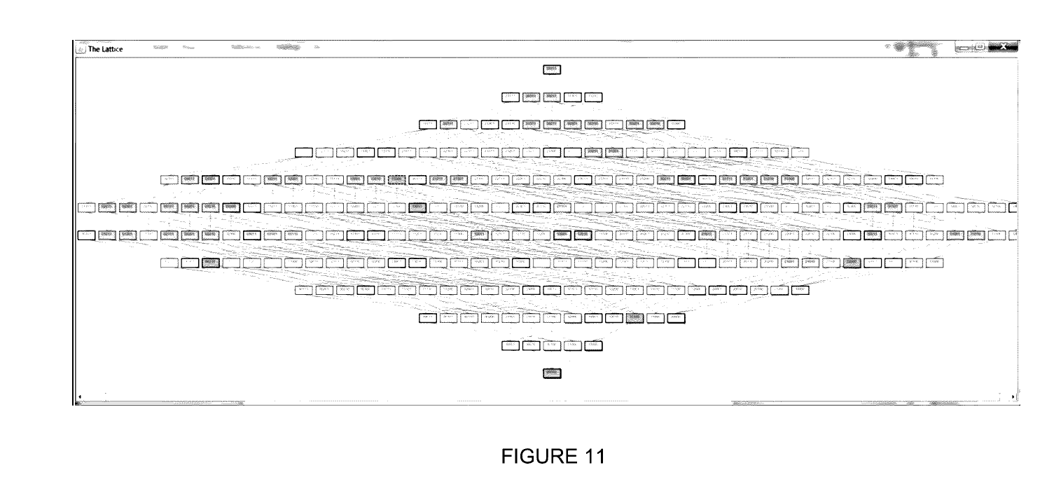

The calculated values are then presented to the display at step 116. FIG. 11 illustrates a sample aggregation lattice graph generated by the visual aggregation modeler tool with the calculated values. In response to the display of the presented values, the user can take action at step 117, branching to one of the several respective steps. Double clicking on a materialized node branches to step 118. In this case, after changing the state of the materialization status of the affected node, the process returns to step 106 to recalculate the derivation base. If the user elects to change settings at step 120, control proceeds to steps 122-126 to set cardinalities (step 122), set weights (step 124), or set thresholds (step 126). The revised values are then used to recalculate the derivation base at step 106.

### Optional Modules

As noted above with respect to FIG. 8, the visual aggregation modeler may incorporate other optional modules 28 and 30 that are not essential but extend utility.

### Optional Module: Graph Search

Module 28 may include a graph search feature that allows the user to select a list of nodes and see their common descendants and union of ascendants highlighted. To add this feature, the following additions are made to the model module 22 shown in FIG. 8. In particular, the model state is modified to declare a selection list on the nodes and “Selection List Dependencies” are calculated. The “User Response and Acceptance” module 26 is also modified to include the capability to point on a node and “Select” it (single click) causing the selection list to be updated. In particular, if the node is not in the list already, it is added to the selection list. If the node is in the selected list, it is removed. On the other hand, if the mouse pointer is over an empty canvas (not pointing to a node), the list is reset. Finally, the display module 24 is modified to render nodes in the selection list with a different color, such as light gray with shadow. All dependent nodes are rendered light gray as a result of the calculation of the “Selection List Dependencies.” This allows selection list dependencies to be displayed to the user for easy comprehension.

### Calculation of “Selection List Dependencies”

The selection list contains zero, one, or many nodes selected by a user at step 132 (FIG. 9). The selection list dependencies are the common descendants and all ascendants of the nodes in the selection list. The set of “descendent” nodes of a given node N is defined to consist of those materialized nodes (including the bottom 0-level) from which node N can be derived by aggregation. Each descendant has respective dimensions at-the-same-level-or-lower than N. The set of “ascendant” nodes of a given node N is defined to consist of those nodes that can be derived from N by aggregation. Each ascendant has respective dimension at-the-same-level-or-higher than N. The descendent set is then calculated at step 134 as follows:
For each node Nᵢ in the selection list:
   Find the set Dᵢ of descendent nodes with all respective dimensions lower or equal level to those of Nᵢ; and
   Find the set Aᵢ of ascendant nodes with all respective dimensions higher or equal to Nᵢ.
Produce result sets for display at display step 116 as follows:
   Common descendants of the selection list as the intersection of sets Dᵢ, and
   All ascendants of the selection list as the union of sets Aᵢ.

### Option: Recasting Avoidance Feature

This feature color-codes the boundary of each node at step 128 (FIG. 9) based on a “materialization desirability” classification whereby recastable aggregates are discouraged except for limited specific dimension levels the user explicitly allows. To implement this feature, the dimension Settings is added to indicate if a dimension is recastable. Recastable dimension specific level overrides are identified to “allow materialization” for those levels that are recast. A model calculation is also added to derive “materialization desirability” from the dimension “recasting” settings. A rendering step is also added to paint the border color derived from materialization desirability. For example, “allow” (black), “discourage” (green), and “avoid” (red) colors may be used.

### Derive “Materialization Desirability”

The materialization desirability is an optional feature that aids the operator in avoiding materialization of recastable dimensions. The visual aggregation modeler tool can be implemented without this capability.

To implement materialization desirability, a discrete classification of nodes is used to make visible to the designer which nodes, if materialized, will be subject to recasting. This is implemented by marking specific dimensions as recastable, and if some recastable aggregates are unavoidable, to limit recasting only to specific levels of these dimensions. Based on these designations, each node of the aggregation lattice can fall into one of three groups:
1. The “Allow” group—Includes all nodes whose underlying aggregation if materialized would not involve recasting due to slow changing dimensions;
2. The “Discourage” group—Includes all nodes that are subject to recasting, but all recastable dimension levels are marked “Allow Recasting”; and
3. The “Avoid” group—Includes all remaining nodes that are subject to recasting, and at least one recastable dimension level is not marked “Allow Recasting.”
   The derivation of this optional classification uses the dimension attribute “recastable” and the dimension level attribute “allow materialization.” The recast attributes are set at step 130 (FIG. 9).

The level for each dimension defining the aggregation level is checked and the node is classified using the following logic. If every dimension defining the node is either non-recastable or its level is a top or bottom level of a recastable dimension, then the node is in the “Allow” Group. From the remaining nodes, those that have at least one recastable dimension at a level not marked “Allow Materialization” belong to the “Avoid” group. All remaining nodes belong to the “Discourage” group.

### Optional Workload Analysis Module

The optional workload analysis module 30 (FIG. 10) is the most extensive add-on module. It adds real query workload analysis capability by the determination of a query's aggregation level, derivation of “free aggregation distance” and the creation of weight profiles that reflect actual workload load distribution. In operation, the user collects actual queries of the appropriate mix at step 206 to define a benchmark workload. These queries can be parsed at step 208 for use at step 212 to construct a weight profile that reflects the way the workload is spread over the various aggregation levels.

A third party SQL parser 208 such as Gudusoft's SQL parser, for example, is employed to parse queries of workload streams creating a parse tree for each query, including all involved subqueries, table expressions and OLAP functions. More specifically, parsing involves returning and storing the following information for each query at step 200:
Identifier (job, timestamp, query ID etc.) that the DBMS uses to identify the query and correlate it to execution statistics and “explain plan” information. This is specific to the technology of the DBMS being optimized.
By searching the parse tree (e.g. Gudusoft's SQL parser which already provides column usage information) record and retain the following information for each table/view and column name referenced in the query:
   Grouping (traced to expression in GROUP BY, PARTITION BY clause)
   Filtering (traced to expression in WHERE or HAVING or RESTRICT clause or ORDER BY of an OLAP function)
   Aggregate function used (Sum, Avg, Max, Count, etc.)
   Distinct Indicator—indicates a distinct count or aggregation over a distinct subquery
By accessing DBMS “monitor” or “explain” information (specific to the DBMS) obtain actual physical objects the optimizer uses for the query.

A column-level manifest is generated at step 202 and ingested at step 204 by enabling the user to edit and maintain a meta-database or manifest that contains every table/column from the DBMS catalog that is involved in the workload with the following details:
Data object: Table or view;
Column name;
Type: “Dimension”, “Metric”, or “Metric Classifier” (see elaboration under Unit Attribute List below);
Dimension Identifier;
Dimension Level;
Metric Classifier list—Identifies one or more columns, other than the metric itself, that partitions the metric into additive domains. A typical example is the classifier “Currency” for metric “Amount”—a summation across different currencies is meaningless, but it is allowed within the same currency. The practical implication is that this Classifier attribute list is part of the group but may not be associated with a level along any dimension. These classifier columns are treated as part of a complex metric type. If the user chooses to include the Unit as a dimension, then it is simply treated as such, and there is no need to include it as a Unit attribute. The problem with such treatment is that aggregation levels for all/any currency are likely to be invalid because they imply summation across multiple currencies. In those cases where the user chooses to include these classifiers in dimensions, the invalid aggregations must be excluded from consideration.
Is the metric additive?—A Boolean value that should be set to “false” for non-additive (e.g. discount rate) or partially additive (month-to-date amount) metrics.
Non-Additive dimension list: the dimensions along which the column is non-additive. This is triggered for all metrics that are non-additive per the previous Boolean value, or when distinct aggregations are identified by the parser.

The workload analysis module 30 further calculates the Query Q-Level at step 210, builds the weight profile at step 212, determines the Query M-Level at step 218, and determines the Free Aggregation Distance at step 220. In particular, the Query Aggregation Level is derived at step 210 from the Query Parse Results of step 208 and the column-mapping manifest produced at step 204 as detailed below. A workload weight profile is then generated at step 212 as a count of queries by aggregation level.

The total free aggregation distance is calculated at step 220 by summing all aggregation distances for representative workloads. This value is a measure of total aggregation cost that can be reduced through aggregate optimization and is a good measure for iterative improvements. It can also be used when the improvements do not involve aggregate changes, but query tuning or logical changes as well. This process includes the additional functions of parsing queries of the workload and extracting execution DBMS details at step 214, querying the actual tables accessed at step 216, and maintaining a column-Level Mapping Manifest for determining the M-Level Query at step 218. The Free Aggregation Distance is calculated by Query Aggregation Level at step 220 as detailed below. The free aggregation distance is a useful metric in assessing actual aggregate effectiveness and determining opportunities for improvement.

### Determination of Query Aggregation Level

The determination of the query aggregation level involves the determination and optional graphing of S-Level, G-Level and Q-Level as defined in the framework and shown in FIGS. 2, 5, and 6 above. If the actual data objects used are cross-referenced using explain-plan or monitor information, then the M-Level can also be determined and graphed. The method used is as follows.

Two sources of information are used. The results of query parsing at step 208 are used with the metadata obtained by the user in the Column-Level Manifest at step 204. The columns that are flagged as “Filtering” in the query parsing result are considered first. The qualified column name is looked up in the Column-Level manifest and the following logic is applied to derive the “S-Level.” In particular:
a. If n is the number of dimensions, initialize an aggregation level S(a₀, . . . ,aₙ) where aᵢ is the top level for dimension i;
b. For each filtering column, if its dimension is j and level cⱼ, replace in S: aⱼ=min(aⱼ, cⱼ);
c. After all filtering columns are so considered, S(a₀, . . . ,aₙ) should contain the lowest encountered level for each dimension. Dimensions that are not involved in filtering will have retained the top level; and
d. The resulting aggregation level is the “S-Level.”

Next, one considers those columns of the query parsing result that are flagged as Grouping. All Grouping columns are looked-up in the Column-Level manifest and the following logic yields the “G-Level”:
a. If n is the number of dimensions, initialize an aggregation level G(a₀, . . . ,aₙ) where aᵢ is the top level for dimension i;
b. For each grouping column, if its dimension is j and level cⱼ, replace in G: aⱼ=min(aⱼ, cⱼ);
c. After all grouping columns are so considered, G(a₀, . . . ,aₙ) should contain the lowest encountered level for each dimension. Dimensions that are not involved in filtering will have retained the top level; and
d. The resulting aggregation level is the “G-Level.”

Along each dimension, the lowest between respective S-Level and G-levels defines the “Raw Q-Level” (Raw Query Level). All aggregated columns are then inspected in the set of AGG=Result columns except Grouping columns as follows:
a. If any AGG column is not part of a MIN, MAX, SUM or COUNT then the Q-level is at the fact base (0-level for all dimensions);
b. If all AGG columns are in MIN, MAX, SUM or COUNT aggregate functions and the distinct indicator is “false,” then look-up the corresponding columns in the Column-Level Manifest. If all columns are additive then use the Raw Q-level as the Q-Level; otherwise
c. If all AGG columns are in MIN, MAX, SUM or COUNT aggregate functions and either the distinct indicator is true, or the additive indicator in the metadata manifest is false for any dimension, replace the non-additive dimensions with 0 leaving the remaining dimensions at the level of the Raw Q-Level; and
d. The resulting level is the Q-Level.

The S-Level, G-Level and Q-Levels are thus defined for a query.

### Determination of the Free Aggregation Distance

As shown in FIG. 10, the Free Aggregation Distance may be calculated at step 220 using the Q-Level already obtained from the algorithm described above. There are three possible ways of obtaining the M-Level. First, the parsed SQL text aggregate metrics are associated with one or more fact tables that may not be the actual object used during the execution of the query, if the optimizer rewrote the query to use some pre-aggregated object (MQT, AJI, MV depending on DBMS technology). Second, the rewritten query by the optimization process may redirect the query to a convenient aggregate. It may require a “plan explain” or monitor information to obtain the actual materialized aggregation used. The way to obtain this information depends on the DBMS. Third, the model may be used to determine where the closest materialized aggregate is derived from the query level. This level is the optimal level for the query based on the Visual Aggregate Modeler costing algorithm. The three versions of the M-Level will result in three different calculations at step 220 of the Free Aggregation Distance (or otherwise referred to as Discretionary Aggregation Cost) respectively:
a. Query M-Level to Q-Level cardinality ratio based on tables referenced in the query text. If the fact is a view, the M-Level of the view is used.
b. Actual M-Level to Q-Level cardinality ratio, can be only derived if the actual M-Level can be extracted from the DBMS.
c. Cardinality ratio of Modeled M-Level to query Q-Level.

Those skilled in the art will appreciate that the facility described herein substantially improves the designer's ability to determine optimal aggregates that improve processing efficiency of the database management system and speed up query processing. As noted, the visual aggregation modeler and the workload analysis module may further facilitate the evaluation and iterative improvement of aggregate performance with existing workloads or the mix of existing and projected workloads. The system and method described herein enables users to perform quantitative evaluations and direct the aggregate selection process using what-if analysis with complex feedback through visualization and iteration. In this fashion, the techniques improve the operation of the database system itself by speeding up query processing.

It should be understood that the systems and methods described herein are not limited to the particular embodiments disclosed, but are intended to cover modifications within the spirit and scope of the present invention as defined by the appended claims. For example, the application can be implemented as a standalone appliance on a dedicated device, be incorporated into server toolkits and other integrated tools, or deployed on general purpose computers that have the required components, or be deployed as a distributed web application. All such aspects are intended to be covered by the appended claims.

What is claimed:

1. A visual aggregation modeler system that enables a user to analyze and optimize materialization of aggregates in a database management system (DBMS) for actual and/or projected workloads, comprising:
a settings module that stores dimensionality data, cardinalities data, and weight profiles for vertices of each aggregation lattice residing in a database that is subject to aggregate analysis,
a model module that retains a model state and a state of each node of each aggregation lattice and composes a topology of the aggregation lattice of said database from at least the dimensionality data, said model module further calculating a query cost score for each node and a total weighted query cost for each node including contributions of said weight profiles;
a display module that renders a display including an aggregation lattice graph including nodes and next rank edges of said aggregation lattice, said display enabling a user to view materialization status and score feedback of each node of the aggregation lattice; and
a user response and acceptance module that enables the user to interact with said aggregation lattice graph to select nodes and change data in said settings module for visualization of the effects of the changed data on the aggregation lattice.

2. The system of claim 1, further comprising a persistent storage that stores settings data, imports/exports files, and stores the state of each node of the aggregation lattice.

3. The system of claim 1, wherein the dimensionality data is entered or imported by the user and the geometry of the aggregation lattice, including the nodes, the next rank edges and the positions of the nodes and next rank edges, is derived from the dimensionality data with a node corresponding to each combination of dimension levels of the dimensionality data, with the geometry of the aggregation lattice remaining constant across the visualizations as long as the dimensionality data is not altered.

4. The system of claim 1, wherein a cardinality value is associated with each node of the aggregation lattice, said cardinality value representing a sizing metric that is a predictor of query aggregation cost that is used in query cost score calculations, wherein a type of the sizing metric is decided by the user as a predictor of performance for said database.

5. The system of claim 4, wherein the model module further uses cardinality ratio thresholds, adjustable by the user, to delineate ranges associated with acceptable, marginal and unacceptable query response times.

6. The system of claim 1, wherein the user response and acceptance module enables a user to iterate and to alter the materialization status, weights and cardinalities of vertices of an aggregation lattice, and upon acceptance of user changes, the system computes and displays the revised aggregation lattice graph and maintains a log of state changes and resulting query cost scores.

7. The system of claim 1, wherein the display module displays the aggregation lattice graph with background and border colors denoting cost scores and status information for the user to direct an iterative selection process of nodes of the aggregation lattice.

8. The system of claim 1, wherein said model module calculates a derivation base of each node, which is a smallest materialized aggregate that each node can be derived from, by searching each materialized node in the transitive closure of descendent nodes and identifying as the derivation base the materialized node with minimum cardinality.

9. The system of claim 8, wherein said model module calculates the query cost score for each node of the aggregation lattice as the ratio of the cardinality of the node's derivation base to the cardinality of the node itself.

10. The system of claim 9, wherein weight profiles are used in the calculation of total weighted query cost for each node, derived as a count of queries per query aggregation level of the aggregation lattice.

11. The system of claim 10, wherein said model module calculates the total weighted query cost by normalizing a weight of each node as a ratio of a weighting of the node to a sum of all weights multiplied by the number of nodes and calculating the total weighted query cost as a sum of the query cost scores multiplied by the respective normalized weight of each node, whereby the weight of each node is proportional to the frequency of its use.

12. The system of claim 8, wherein said model module calculates a total maintenance cost score as a number proportional to a projected cost of building each materialized aggregate from its derivation base.

13. The system of claim 9, wherein said model module translates said query cost score to a color that said display module renders on said display to reflect a comparison of the cardinality ratio to at least one threshold indicating a cost of the query.

14. The system of claim 1, wherein the model module further quantifies aggregation cost opportunity for each query executed by said database management system by calculating a query intrinsic aggregation cost as aggregation cost inherent to the query that cannot be improved by aggregations, and a free aggregation distance as a score approximating a run-time cost incurred to aggregate data of a materialized aggregate or base table used by the query up to the query aggregation level.

15. The system of claim 14, wherein a total and an average free aggregation distance are calculated by summing free aggregation distances of all queries by aggregation level or by averaging free aggregation distances of all queries by aggregation level respectively, wherein a benchmark total free aggregation distance calculated by summing weighted free aggregation distances according to a weight profile in effect across all aggregation levels provides a metric of a capacity for improvement of performance through aggregations for an assumed workload associated with a weight profile and existing structures in said DBMS.

16. The system of claim 14, wherein values for said free aggregation distance are tracked over consecutive iterations of aggregate enhancements so as to capture a relative reduction of aggregation cost that can be attributed to changes in materialized aggregates.

17. The system of claim 1, further comprising a workload module that provides to the model module a column-level manifest including a mapping between table/columns to a characterization as a dimension level or metric.

18. The system of claim 17, wherein a query aggregation level of an actual query of the database is computed by parsing the actual query and calculating the query aggregation level from selection and grouping aggregation levels which are in turn calculated based on the dimension level characterization of columns involved in selection and grouping, respectively, according to the column-level manifest.

19. The system of claim 17, further comprising an interface to the workload management module that prioritizes query workload of said DBMS and collects a history of executed queries, text of executed queries, and of objects accessed during execution of the queries.

20. The system of claim 19, wherein the interface to the workload management module further collects a history of CPU, memory and I/O resources consumed by executed queries and elapsed time and size of a result during execution of the queries.

21. The system of claim 1, further comprising a graph search module that is adapted to enable the user to select a list of nodes from the display of said aggregation lattice graph and to see the nodes' common descendants and a union of the nodes' ascendants highlighted on said display.

22. The system of claim 21, wherein the graph search module calculates selection list dependencies of the selected nodes as common descendants of all selected nodes from which all of the selected nodes can be derived by aggregation, and the union of all ascendants of each selected node N as those nodes that can be derived from node N by aggregation.

23. The system of claim 1, wherein the user response and acceptance module enables the user to color code a perimeter of each node in the aggregation lattice based on a materialization desirability to control recasting of aggregates.

24. The system of claim 23, wherein materialization desirability is derived from recasting settings stored by said settings module and each selected node is placed in one of three groups: an allow group that allows materialization for nodes that are not subject to recasting, a discourage materialization group where recasting has been enabled by the user for affected dimensions and levels of the aggregation lattice, and an avoid materialization group that involves recasting due to dimension and levels that the user has not approved for recasting.

25. A method of enabling a user to analyze and optimize materialization of aggregates of database queries for an actual and/or a projected workload of a database management system (DBMS), comprising the steps of:
creating an aggregation lattice of said database from dimensionality data, cardinalities data, and weight profiles of vertices of said aggregation lattice residing in a database that is subject to aggregate analysis;
composing a topology of the aggregation lattice of said database from at least the dimensionality data and calculating a query cost score for each node and a total weighted query cost for each node including contributions of said weight profiles;
displaying an aggregation lattice graph including nodes and next rank edges of said aggregation lattice, the aggregation lattice graph enabling a user to view materialization status and score feedback of each node of the aggregation lattice;
accepting input from the user to select nodes of said aggregation lattice using said aggregation lattice graph and to change data used to make said aggregation lattice;
calculating the query cost score for each node and the total weighted query cost for each node using the user input; and
displaying a revised aggregation lattice graph including a revised materialization status for the selected node(s).

26. The method of claim 25, further comprising receiving the dimensionality data and the geometry of the aggregation lattice from user input, deriving the aggregation lattice geometry including the nodes, the next rank edges and the positions of the nodes and next rank edges from the dimensionality data with a node corresponding to each combination of dimension levels of the dimensionality data, wherein the geometry of the aggregation lattice remains constant across the visualizations as long as the dimensionality data is not altered.

27. The method of claim 25, further comprising associating a cardinality value with each node of the aggregation lattice, said cardinality value representing a sizing metric that is a predictor of query aggregation cost that is used in query cost score calculations, wherein a type of the sizing metric is decided by the user as a predictor of performance for said database.

28. The method of claim 27, further comprising using cardinality ratio thresholds, adjustable by the user, to delineate ranges associated with acceptable, marginal and unacceptable query response times.

29. The method of claim 25, wherein accepting user input comprises enabling the user to iterate and to alter the materialization status, weights and cardinalities of vertices of an aggregation lattice, and upon acceptance of user changes, computing and displaying the revised aggregation lattice graph and maintaining a log of state changes and resulting query cost scores.

30. The method of claim 25, wherein displaying the aggregation lattice graph comprises displaying background and border colors denoting cost scores and status information of the aggregation lattice graph to direct the user in an iterative selection process of nodes of the aggregation lattice.

31. The method of claim 25, further comprising calculating a derivation base of each node, which is a smallest materialized aggregate that each node can be derived from, by searching each materialized node in the transitive closure of descendent nodes and identifying as the derivation base the materialized node with minimum cardinality.

32. The method of claim 31, further comprising calculating the query cost score for each node of the aggregation lattice as the ratio of the cardinality of the node's derivation base to the cardinality of the node itself.

33. The method of claim 32, further comprising using weight profiles in the calculation of total weighted query cost for each node, derived as a count of queries per query aggregation level of the aggregation lattice.

34. The method of claim 33, further comprising calculating the total weighted query cost by normalizing a weight of each node as a ratio of a weighting of the node to a sum of all weights multiplied by the number of nodes and calculating the total weighted query cost as a sum of the query cost scores multiplied by the respective normalized weight of each node, whereby the weight of each node is proportional to the frequency of its use.

35. The method of claim 31, further comprising calculating a total maintenance cost score as a number proportional to a projected cost of building each materialized aggregate from its derivation base.

36. The method of claim 32, further comprising translating said query cost score to a color that said display module renders on said display to reflect a comparison of the cardinality ratio to at least one threshold indicating a cost of the query.

37. The method of claim 25, further comprising quantifying aggregation cost opportunity for each query executed by said database management system by calculating a query intrinsic aggregation cost as aggregation cost inherent to the query that cannot be improved by aggregations, and a free aggregation distance as a score approximating a run-time cost incurred to aggregate data of a materialized aggregate or base table used by the query up to the query aggregation level.

38. The method of claim 37, further comprising calculating a total and an average free aggregation distance by summing free aggregation distances of all queries by aggregation level or by averaging free aggregation distances of all queries by aggregation level, respectively, wherein a benchmark total free aggregation distance calculated by summing weighted free aggregation distances according to a weight profile in effect across all aggregation levels provides a metric of a capacity for improvement of performance through aggregations for an assumed workload associated with a weight profile and existing structures in said DBMS.

39. The method of claim 37, further comprising tracking values for said free aggregation distance over consecutive iterations of aggregate enhancements so as to capture a relative reduction of aggregation cost that can be attributed to changes in materialized aggregates.

40. The method of claim 25, further comprising receiving from a workload module a column-level manifest including a mapping between table/columns to a characterization as a dimension level or metric.

41. The method of claim 40, further comprising computing a query aggregation level of an actual query of the database by parsing the actual query and calculating the query aggregation level from selection and grouping aggregation levels which are in turn calculated based on the dimension level characterization of columns involved in selection and grouping, respectively, according to the column-level manifest.

42. The method of claim 40, further comprising prioritizing query workload of said DBMS and collecting a history of executed queries, text of executed queries, and of objects accessed during execution of the queries.

43. The method of claim 42, further comprising collecting a history of CPU, memory and I/O resources consumed by executed queries and elapsed time and size of a result during execution of the queries.

44. The method of claim 25, further comprising enabling the user to select a list of nodes from a display of said aggregation lattice graph and to see the nodes' common descendants and a union of the nodes' ascendants highlighted on said display.

45. The method of claim 44, further comprising calculating selection list dependencies of the selected nodes as common descendants of all selected nodes from which all of the selected nodes can be derived by aggregation, and the union of all ascendants of each selected node N as those nodes that can be derived from node N by aggregation.

46. The method of claim 25, further comprising enabling the user to color code a perimeter of each node in the aggregation lattice based on a materialization desirability to control recasting of aggregates.

47. The method of claim 46, further comprising deriving materialization desirability from recasting settings and placing each selected node in one of three groups: an allow group that allows materialization for nodes that are not subject to recasting, a discourage materialization group where recasting has been enabled by the user for affected dimensions and levels of the aggregation lattice, and an avoid materialization group that involves recasting due to dimension and levels that the user has not approved for recasting.
